(19) United States
(12) Patent Application Publication
(10) Pub. No.: US 2025/0157193 A1
(43) Pub. Date: May 15, 2025

(54) FEATURE EXTRACTION MODEL GENERATING METHOD, IMAGE FEATURE EXTRACTING METHOD AND APPARATUS

(71) Applicant: Beijing Zitiao Network Technology Co., Ltd., Beijing (CN)

(72) Inventors: Jiawen LI, Beijing (CN); Yuanfan GUO, Beijing (CN)

(21) Appl. No.: 18/833,352

(22) PCT Filed: Jan. 9, 2023
(86) PCT No.: PCT/CN2023/071358

§ 371 Date: Jul. 25, 2024

(30) Foreign Application Priority Data
Jan. 26, 2022 (CN) 202210096198.2

(51) Int. Cl. G06V 10/77; G06V 10/74; G06V 10/762; G06V 10/774

(52) U.S. Cl. CPC G06V 10/7715; G06V 10/761; G06V 10/7625; G06V 10/774

(57) ABSTRACT

The disclosure relates to a method for generating a feature extraction model, and a method and apparatus for image feature extraction, the method comprising: obtaining a plurality of candidate images; determining a clustering tree corresponding to the plurality of candidate images based on a feature extraction model and the plurality of candidate images, wherein the clustering tree comprises clusters at a plurality of layers; generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate image and features of a cluster center of the clustering; and training the feature extraction model based on the target sample pair.

### CROSS REFERENCE TO RELATED APPLICATION(S)

This is a national stage application based on International Patent Application No. PCT/CN2023/071358, filed Jan. 9, 2023, which claims priority to Chinese Application No. 202210096198.2 entitled “feature extraction model generating method, image feature extracting method and apparatus” filed with the Chinese Patent office on Jan. 26, 2022, the disclosures of which are incorporated herein by reference in their entities.

### FIELD

The present disclosure relates to the field of image processing, and specifically, to a method for generating a feature extraction model, a method and apparatus for image feature extraction.

### BACKGROUND

There is a hierarchical semantic structure in natural image data sets. Taking the classification of animal images as an example, images corresponding to Labradors and Poodles can be classified into the category of “dog”, while “dog”, “cat” and “monkey” and other categories can be further classified into the category of “mammal”.

However, in the related art, self-supervised learning based on contrastive learning cannot model the above-mentioned hierarchical semantic structure. Therefore, in the event of classification based on contrastive learning, only local semantics can be learned from different sample images of the same granularity, making the features of different images far away from each other in the feature space. However, the processing of each sample image with various differences is the same, which is difficult to apply to the above-mentioned higher-level scenarios.

### SUMMARY

The Summary is to introduce a selection of concepts in a simplified form that are further described below in the Detailed Description. The Summary is not intended to identify key features or essential features of the present disclosure, nor is it intended to be used to limit the scope of the present disclosure.

In a first aspect, the present disclosure provides a method of feature extraction model generation, comprising:
obtaining a plurality of candidate images;
determining a clustering tree corresponding to the plurality of candidate images based on a feature extraction model and the plurality of candidate images, wherein the clustering tree comprises clusters at a plurality of layers;
generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
training the feature extraction model based on the target sample pair.

In a second aspect, the present disclosure provides a method for image feature extraction, the method comprising:
receiving an image to be processed; and
inputting the image to be processed into a feature extraction model to obtain a feature image output by the feature extraction model, wherein the feature extraction model is generated based on the method of feature extraction model generation according to the first aspect.

In a third aspect, the present disclosure provides an apparatus for feature extraction model generation, the apparatus comprising:
an obtaining module configured for obtaining a plurality of candidate images;
a determining module configured for determining a clustering tree corresponding to the plurality of candidate images based on a feature extraction model and the plurality of candidate images, wherein the clustering tree comprises clusters at a plurality of layers;
a generating module configured for generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
a training module configured for training the feature extraction model based on the target sample pair.

In a fourth aspect, the present disclosure provides an apparatus for image feature extraction, the apparatus comprising:
a receiving module configured for receiving an image to be processed; and
an extracting module configured for inputting the image to be processed into a feature extraction model to obtain a feature image output by the feature extraction model, wherein the feature extraction model is generated based on the method of feature extraction model generation according to the first aspect.

In a fifth aspect, the present disclosure provides a computer-readable medium, storing a computer program thereon, wherein the program, when executed by a processing device, implements the steps of the method according to the first aspect.

In a sixth aspect, the present disclosure provides an electronic device, comprising:
a storage device, storing at least one computer program thereon;
at least one processing device, for executing the at least one computer program in the storage device to implement the steps of the method according to the first aspect.

Other features and advantages of the present disclosure will be explained in detail in the DETAILED DESCRIPTION section below.

### BRIEF DESCRIPTION OF THE DRAWINGS

The above and other features, advantages and aspects of the present disclosure will become more apparent in combination with the accompanying drawings and with reference to the following specific implementations. The same or similar reference symbols refer to the same or similar elements throughout the figures. It should be understood that the figures are merely schematic, and components and elements are not necessarily drawn scale.

FIG. 1 is a flowchart of a method for generating a feature extraction model according to an implementation of the present disclosure;

FIG. 2 is a schematic diagram of a clustering tree provided according to an implementation of the present disclosure;

FIG. 3 is a block diagram of an apparatus for generating a feature extraction model provided according to an implementation of the present disclosure; and

FIG. 4 shows a schematic structural diagram of an electronic device suitable for implementing the embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in the method implementations of the present disclosure may be performed in a different order and/or in parallel. In addition, the method implementations may comprise an additional step and/or omit a step which is shown. The scope of the present disclosure is not limited in this regard.

The term “comprise” and its variants used herein are to be read as open terms that mean “include, but is not limited to.” The term “based on” is to be read as “based at least in part on.” The term “one embodiment” is to be read as “at least one embodiment.” The term “another embodiment” is to be read as “at least one other embodiment.” The term “some embodiments” is to be read as “at least some embodiments.” Other definitions, either explicit or implicit, may be included below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more.”

Names of messages or information interacted between a plurality of apparatuses in the implementations of the present disclosure are merely for the illustration purpose, rather than limiting the scope of these messages or information.

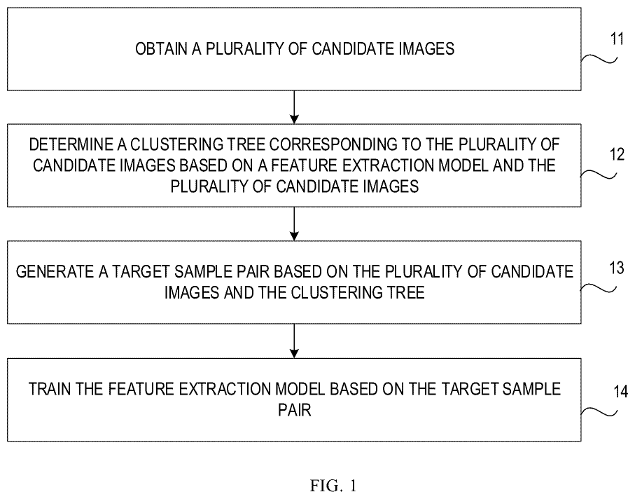

FIG. 1 shows a flowchart of a method for generating a feature extraction model according to an implementation of the present disclosure. The method may comprise:

In step 11, a plurality of candidate images are obtained, wherein the candidate images may be all images in a dataset used for training the feature extraction model. In step 12, a clustering tree corresponding to the plurality of candidate images is determined based on the feature extraction model and the plurality of candidate images, wherein the clustering tree contains clusters under a plurality of layers.

In this step, features of the candidate images can be clustered under different granularities by hierarchically clustering the candidate images, so that the candidate images can be divided into different classification layers.

For example, the example implementation of determining the clustering tree corresponding to the plurality of candidate images based on the feature extraction model and the plurality of candidate images may comprise:

A sample feature corresponding to each of the candidate images is obtained by performing feature extraction on the plurality of candidate images based on the feature extraction model. For example, each candidate image can be input into the current feature extraction model, so that the sample feature corresponding to each candidate image can be output through the feature extraction model.

A plurality of clusters and a cluster center of each cluster are generated by clustering based on each target feature, the target feature being the sample feature initially.

As an example, clustering can be performed based on a bottom-up clustering approach. If the target feature is initially the sample feature corresponding to each candidate image, clustering can be performed based on a distance between the sample features. The distance can be calculated using Manhattan distance, Euclidean or Pearson similarity, which is not limited in the present disclosure. Thus, S cluster centers can be obtained by clustering based on the sample feature corresponding to the candidate image, where S is used to represent the number of clusters obtained by clustering based on the sample features. For the sake of explanation, this layer can be recorded as S layer.

Afterwards, the cluster center of each cluster is used as a new target feature, and hierarchical clustering is performed until the layer of the obtained clustering tree reaches a predetermined level.

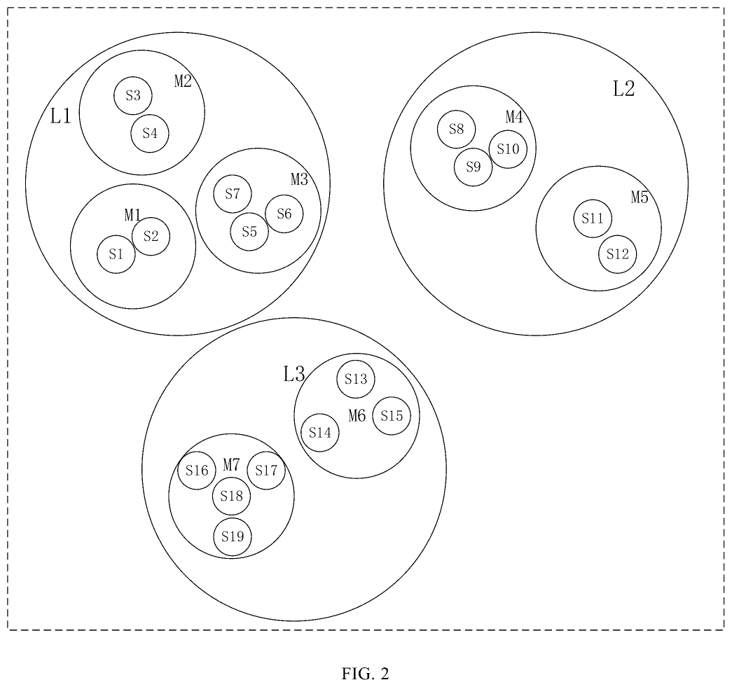

Accordingly, clustering can be continued based on the S cluster centers to obtain M new cluster centers, where M is smaller than S. For the sake of description, the layer containing the M new cluster centers can be recorded as M layer. The depth of the clustering tree formed at this time is 2, that is, the bottom layer contains S cluster centers, and the upper layer contains M cluster centers. If the predetermined layer is 3, clustering can be performed again based on M cluster centers to obtain L higher-layer cluster centers, where L is smaller than M. At this time, the layer of the clustering tree reaches the predetermined layer, and the clustering is ended to obtain the clustering tree with completed clusters. For the sake of description, the layer containing L higher-layer cluster centers can be recorded as L layer, as shown in FIG. 2.

It can be seen from the above that a clustering tree containing a plurality of layers can be obtained by clustering the features of a plurality of candidate images used for training. The hierarchical semantics of the candidate image can be characterized based on the clustering tree to facilitate the improvement of the comprehensiveness and accuracy of features of the candidate image.

In step 13, a target sample pair is generated based on the plurality of candidate images and the clustering tree, where the target sample pair comprises an image sample pair and a feature sample pair, the image sample pair is formed based on two different candidate images, and the feature sample pair is formed based on features of the candidate image and features of the cluster centers of the clusters.

The user does not need to annotate in the learning process of contrastive learning. Instead, sample pairs are constructed based on sample images, and learning is performed based on each sample pair. In this embodiment, when determining sample pairs based on candidate images, on the one hand, the sample pairs can be constructed based on the candidate images themselves. On the other hand, as mentioned above, the clustering tree contains clusters at a plurality of layers, the cluster center under each layer can characterize the classification features of this layer, and then the sample pairs can be further determined based on the features of the candidate images and the features of the cluster center to improve the accuracy and diversity of the sample pairs.

In step 14, the feature extraction model is trained based on the target sample pair.

For example, a trained feature extraction model can be obtained based on the target sample pair and by using a learning approach based on contrastive learning commonly used in the art.

Therefore, with the above technical solution, when generating a feature extraction model based on candidate images, the sample pairs are not determined directly based on the candidate images, but a clustering tree containing a plurality of layers is generated based on the current feature extraction model and the candidate images. In this way, the hierarchical semantics of the candidate images can be characterized, and local semantics at different granularities can be learned when classifying based on contrastive learning, which improves the accuracy of the feature extraction model and provides accurate data support for subsequent image classification, image recognition and the like. Moreover, in the solution of the present disclosure, when generating sample pairs, the determining can be made based on the clustering tree and candidate images, and the obtained sample pairs can include image sample pairs and feature sample pairs. Thereby, the accuracy, comprehensiveness and diversity of sample pairs used in generating the feature extraction model can further be improved, the accuracy and effectiveness of the training data of the feature extraction model can be increased to a certain extent, and further the training efficiency and stability of the generated feature extraction model can be improved and the application scope of the feature extraction model can be expanded.

In one possible embodiment, an example implementation of generating the target sample pairs based on the plurality of candidate images and the clustering tree in step 13 is as follows. This step may comprise:

A sample image set and a candidate contrast image set are generated based on the candidate images, where images in the candidate contrast image set are different from images in the sample image set, and the number of images corresponding to the candidate contrast image set is greater than the number of images corresponding to the sample images.

W images can be randomly selected from the candidate images as sample images and added to the sample image set X, and Q images can be selected from the candidate images other than the W images as candidate contrast images and added to the candidate contrast image set H, where W and Q are positive integers, and W is less than Q.

For each sample image in the sample image set, a contrast sample set of the sample image under each layer is determined based on a candidate contrastive image in the candidate contrast image set and the cluster center of the cluster at each layer in the clustering tree, a contrastive sample in the contrastive sample set comprising features of a target contrast image and a target contrast cluster center.

As mentioned above, when generating the feature extraction model, sample pairs need to be constructed, and each sample pair can contain two images or two feature vectors. Each sample image in the sample image set is used to generate a target sample pair. The granularity of feature semantics under each layer of the clustering tree is different. In the embodiments, when generating a target sample pair based on a sample image, for each layer in the clustering tree, the corresponding contrast image and contrast cluster center of the sample image under the layer may be determined, and then an analysis and determining can be made separately for each layer, thereby improving the accuracy of the contrast sample set corresponding to the sample image.

Afterwards, for each sample image in the sample image set, a negative sample pair corresponding to the sample image at each layer is generated based on the sample image and a contrast sample set of the sample image at each layer, and the negative sample pair is determined as the target sample pair.

For example, for each sample image in the sample image set, according to the sample image and the contrast sample set of the sample image at each layer, the sample image and a plurality of contrast samples in the contrast sample set at the layer can be formed into negative sample pairs respectively, and the plurality of contrast samples may be part or all of the samples in the contrast sample set. For example, for the sample image X1, its contrast sample set DS under the S layer contains K contrast samples, then some or all of the K contrast samples can be selected to form negative sample pairs with the sample image X1, for example, (X1, DS1), (X1, DS2), . . . , (X1, DSK) and so on, a total of K pairs of negative sample pairs. For the sample image X1, its contrast sample set DM under the M layer contains J contrast samples, then some or all of the J contrast samples can be selected to form negative sample pairs with the sample image X1, for example, (X1, DM1), (X1, DM2), . . . , (X1, DMJ) and so on, a total of J pairs of negative samples. The approach of generating target sample pairs for other layers and other sample images is similar to that described above and will not be repeated here.

Therefore, with the above technical solution, after the sample image set and the candidate contrast image set are determined, the contrast sample corresponding to the sample image set can be selected from the candidate contrast image set at each layer based on the clustering tree, the contrast cluster center corresponding to the sample image at each layer can be determined based on the clustering tree. Thus, while accurately filtering the contrast samples of the sample image, the contrast samples can be determined for each layer, so that the semantic features at different layers can be learned when training the feature extraction model based on the target sample. Therefore, the features of different images can be distributed differently in the feature space at different layers when performing feature extraction based on the feature extraction model, improving the accuracy of the feature extraction model.

In one possible embodiment, an example implementation of determining the contrast sample set of the sample image at each layer based on the candidate contrast images in the candidate contrast image set and the cluster center of the cluster at each layer in the clustering tree is as follows. This step comprises: A hierarchical cluster center to which the sample image belongs at each layer in the clustering tree is determined.

As an example, feature extraction can be performed on the sample image based on the feature extraction model, so that for each layer in the clustering tree, the distance between the features of the sample image and each cluster center at the layer can be calculated, and a cluster center with the smallest distance is determined as the hierarchical cluster center to which the sample image belongs at this layer.

For each layer in the clustering tree, the target contrast image corresponding to the sample image at the layer is determined based on the hierarchical cluster center to which the sample image belongs under the layer and the candidate contrast images in the candidate contrast image set.

As an example, this step can be implemented as follows.

For each layer in the clustering tree, an image similarity between the hierarchical cluster center of the sample image under the layer and each candidate contrast image in the candidate contrast image set is determined. Each candidate contrast image can be input into the feature extraction model to obtain the features of the candidate contrast image. Then the image similarity is calculated based on the features of the candidate contrast image and the hierarchical cluster center, where the calculation can be based on cosine similarity. The image similarity can represent a probability that the candidate contrast image and the sample image belong to the same cluster at this layer.

Afterwards, if the image similarity is greater than a first threshold, it means that the similarity between the sample image and the candidate contrast image is relatively high, and the probability that the sample image and the candidate contrast image belong to the same cluster at this layer is relatively high. At this time, it is inappropriate to use the candidate contrast image as a contrast sample for the sample image. Therefore, in this embodiment, the candidate contrast image whose image similarity is greater than the first threshold can be ignored, and a candidate contrast image whose image similarity is less than or equal to the first threshold can be used as the target comparison image.

As another example, the implementation of the step of, for each layer in the clustering tree, determining the target contrast image corresponding to the sample image under the layer based on the hierarchical cluster center to which the sample image belongs at the layer and the candidate contrast images in the candidate contrast image set may comprise:

For each layer in the clustering tree, an image similarity between the hierarchical cluster center of the sample image under the layer and each candidate contrast image in the candidate contrast image set is determined. The method of calculating the image similarity has been described above and will not be repeated here.

After the image similarity is determined, random sampling can be performed based on the image similarity. When a result of the random sampling is rejection, the candidate contrast image is determined as the target contrast image of the sample image at the layer.

For example, the image similarity is p, and random sampling can take p as the input, thereby outputting 1 with a probability of p, and outputting 0 with a probability of 1-p. It is determined that the output 1 means acceptance and the output 0 means rejection. When the result of the random sampling is acceptance, it means that the sample image and the candidate contrast image belong to the same cluster at this layer; when the result of the random sampling is rejection, it means that the sample image and the candidate contrast image do not belong to the same cluster at this layer. In this embodiment, to determine the contrast sample corresponding to the sample image is to determine the sample that is different from the sample image, that is, the candidate contrast image for which the result of the random sampling is rejection can be determined as the target contrast image. For example, where random sampling is performed based on the image similarity p, if the sampling result is 0, the candidate contrast image is determined as the target contrast image of the sample image at the layer.

Therefore, with the above technical solution, for each layer in the clustering tree, the target contrast image corresponding to the sample image at the layer can be determined by determining the similarity between the candidate contrast image and the hierarchical cluster center to which the sample image belongs at this layer. Hence, it can be avoided that the target contrast image belonging to the same cluster as the sample is used as the contrast sample, ensuring the accuracy of the determined contrast sample and improving the accuracy of the feature extraction model. In addition, a random sampling is performed using image similarity as a probability to determine a contrast sample based on the sampling result. Further, random sampling can be introduced to increase the flexibility of contrast sample selection.

For each layer in the clustering tree, the target contrast cluster center corresponding to the sample image at the layer is determined based on the hierarchical cluster center to which the sample image belongs at the layer and each cluster center in the clustering tree.

As an example, this step can be implemented as follows:

For example, for each layer in the clustering tree, other cluster centers than the hierarchical cluster center to which the sample image belongs at the layer are all different to the hierarchical cluster center, and then all the other hierarchical cluster centers than the hierarchical cluster center at the layer can be directly determined as the corresponding target cluster centers at the layer.

For example, as shown in the clustering tree in FIG. 2, the hierarchical cluster center to which the sample image X1 belongs at the S layer is S1, the hierarchical cluster center to which the sample image X1 belongs at the M layer is M1, and the hierarchical cluster center to which the sample image X1 belongs at the L layer is L1. Then for the S layer, other cluster centers (i.e., S2-S17) at the S layer except S1 can be used as the target contrast cluster center corresponding to the S layer; for the M layer, other cluster centers (i.e. M2-M7) at the M layer except M1 can be used as the target contrast cluster centers corresponding to the M layer; for the L layer, other cluster centers (i.e. L2 and L3) at the L layer except L1 can be used as the target contrast cluster centers corresponding to the L layer.

As another example, the example implementation of, for each layer in the clustering tree, determining the target contrast cluster center corresponding to the sample image at the layer based on the hierarchical cluster center to which the sample image belongs at the layer and each cluster center in the clustering tree is as follows. This step may comprise:

For each layer in the clustering tree except the highest layer, a feature similarity is determined between a parent cluster center corresponding to the hierarchical cluster center of the sample image at the layer and the hierarchical cluster center except the hierarchical cluster center at the layer.

As shown in the clustering tree shown in FIG. 2, the highest layer is the L layer. Taking the S layer as an example, the hierarchical cluster center to which the sample image X1 belongs at the S layer is S1, and the corresponding parent cluster center of the hierarchical cluster center S1 is M1, and the candidate cluster centers of the S layer are S2-S17. Then the similarity calculation can be performed based on the features of each center in S2-S17 and M1, where the similarity can be cosine similarity, which is not limited here. The higher the determined feature similarity, the greater the probability that the hierarchical cluster center to which the sample image belongs and the candidate cluster center belong to the same parent cluster.

Random sampling is performed based on the feature similarity, and when the result of the random sampling is rejection, the candidate cluster center is determined as the target contrast cluster center corresponding to the sample image at the layer.

The method of random sampling is similar to that described above and will not be repeated here. When the result of the random sampling is acceptance, it means that the hierarchical cluster center to which the sample image belongs and the candidate cluster center belong to the same parent cluster. When the result of the random sampling is rejection, it means the hierarchical cluster center to which the sample image belongs and the candidate cluster center does not belong to the same parent cluster. In this embodiment, to determine the contrast sample corresponding to the sample image is to determine the sample that is different to the sample image, that is, the candidate cluster center for which the result of the random sampling is rejection can be used as the target contrast cluster center. For example, random sampling is performed based on the feature similarity p′, and if the sampling result is 0, the candidate contrast cluster center is determined as the target contrast cluster center of the sample image at the layer.

Therefore, with the above technical solution, the target contrast cluster center can be determined from the candidate contrast cluster centers by further analyzing the candidate contrast cluster centers at each layer other than the hierarchical cluster center to which the sample image belongs. Thus, the accuracy and number of contrast samples corresponding to the sample image can be effectively increased, and the accuracy of negative sample pairs in the contrastive learning process can be improved. In addition, by performing a random sampling with the feature similarity as a probability to determine the contrast sample based on the sampling result, the flexibility of contrast sample selection can be increased by introducing random sampling, and further the comprehensiveness of the contrast samples can be improved.

For the highest layer in the clustering tree, candidate cluster centers at the highest layer except the hierarchical cluster center corresponding to the sample image are sampled. When a result of the sampling is rejection, the candidate cluster centers are determined as the target contrast cluster center corresponding to the sample image at the layer.

Continuing the above example, as shown in FIG. 2, for the highest layer L layer, candidate cluster centers except the hierarchical cluster center L1 corresponding to the sample image X1 at the highest layer are uniformly sampled, and when a result of the sampling is rejection, the candidate cluster centers are determined as the target contrast cluster center corresponding to the sample image at the level. For example, uniform sampling can be performed with a probability of 0.5 to select the corresponding target contrast cluster center from the candidate cluster centers. Thus, while ensuring the flexibility of the target contrast cluster center, the accuracy of the target cluster center can be ensured to improve the reliability and effectiveness of the determined negative sample pairs.

Optionally, the example implementation of generating the target sample pair based on the plurality of candidate images and the clustering tree may further include:

For each sample image in the sample image set, a positive sample pair corresponding to the sample image is generated based on a transformed image corresponding to the sample image and the hierarchical cluster center to which the sample image belongs at each layer of the clustering tree.

As an example, for each sample image, transformed images from different viewing angles of the sample image can be obtained through different random transformations, so that the sample pair corresponding to the transformed image and the sample image can be used as a positive sample pair.

As another example, for each sample image in the sample image set, the hierarchical cluster center to which the sample image belongs at each layer in the clustering tree is determined. The method of determining each hierarchical cluster center has been described in detail above and will not be repeated here. Afterwards, the features of the sample image and the central feature of S1 can be used as a positive sample pair, the features of the sample image and the central feature of M1 can be used as a positive sample pair, and the features of the sample image and the central feature of L1 can be used as a positive sample pair, that is, the feature positive sample pairs corresponding to the sample image at each layer can determined.

Therefore, with the above technical solution, positive sample pairs corresponding to the sample images can be quickly generated, and in the process of generating positive sample pairs, different samples can also be generated based on the cluster centers at different layers, and the hierarchical semantics in the positive sample pairs are characterized and constructed to improve the feature accuracy of positive sample pairs in the contrastive learning process and provide data support for improving the learning accuracy of the feature extraction model.

In one possible embodiment, the example implementation of training the feature extraction model based on the target sample pair is as follows. This step may comprise:

A target loss of the feature extraction model is determined based on the target sample pair and a sample label of the target sample pair.

As an example, the target loss can be determined through a contrastive learning loss function commonly used in the art based on the positive sample pair and the negative sample pair in the target sample pair. As another example, when determining the target loss, the loss can be calculated separately for each layer to determine the final target loss. The target loss Loss can be determined through the following formula:

$$Loss = {\sum }_{i = 1}^{n} - log \frac{exp ( sim ( q \cdot {k}^{+} ) )}{{\sum }_{k ∈ {N}_{i} ( q )} exp ( sim ( q \cdot k ) )} + {\sum }_{i = 1}^{n} - log \frac{exp ( sim ( q \cdot {k}_{i}^{+} ) )}{{\sum }_{k ∈ {N}_{i} ( q )} exp ( sim ( q \cdot k ) )}$$

where n is used to represent the number of layers in the clustering tree;
Nᵢ(q) is used to represent the contrast sample set of the sample image q at the i-th layer;
k is used to represent the contrast sample in the contrast sample set corresponding to the sample image q;
sim( ) is used to represent similarity calculation; exp( ) is used to represent exponent calculation;
k⁺ is used to represent the transformed image in the positive sample pair corresponding to the sample image q;
kᵢ⁺ is used to represent the hierarchical cluster center in the positive sample pair of the sample image q at the i-th layer.

If an iteration ending condition is not met, parameters of the feature extraction model are updated based on the target loss, to obtain an updated feature extraction model.

The iteration ending condition is that the target loss is less than or equal to a loss threshold, or the number of iterations of the feature extraction model is greater than a number threshold. The loss threshold and number threshold can be set based on actual application scenarios, which is not limited in the present disclosure. The parameters of the feature extraction model can be updated using the gradient descent method based on the target loss, which will not be repeated here.

A clustering tree corresponding to the plurality of candidate images is determined based on the updated feature extraction model and the plurality of candidate images.

A new target sample pair is generated based on the plurality of candidate images and the newly determined clustering tree, to train the feature extraction model based on the new target sample pair until the iteration ending condition is met and a trained feature extraction model is obtained.

The specific implementations for determining the above steps have been described above and will not be repeated here. In this embodiment, after the feature extraction model is updated, feature extraction can be performed on the plurality of candidate images based on the updated feature extraction model to determine a new clustering tree and further determine the training samples in the next round. Therefore, during the training process of the feature extraction model, the clustering tree can be regenerated and new training samples can be determined based on the updated feature extraction model by continuously updating the feature extraction model, thereby increasing the accuracy of the clustering tree and training samples and effectively improving the training efficiency of the feature extraction model.

With the above technical solution, when generating a feature extraction model based on candidate images, the sample pairs are not determined directly based on the candidate images, but a clustering tree containing a plurality of layers is generated based on the current feature extraction model and the candidate images. In this way, the hierarchical semantics of the candidate images can be characterized, and local semantics at different granularities can be learned when classifying based on contrastive learning, which improves the accuracy of the feature extraction model and provides accurate data support for subsequent image classification, image recognition and the like. Moreover, in the solution of the present disclosure, when generating sample pairs, the determining can be made based on the clustering tree and candidate images, and the obtained sample pairs can include image sample pairs and feature sample pairs. Thereby, the accuracy, comprehensiveness and diversity of sample pairs used in generating the feature extraction model can further be improved, the accuracy and effectiveness of the training data of the feature extraction model can be increased to a certain extent, and further the training efficiency and stability of the generated feature extraction model can be improved and the application scope of the feature extraction model can be expanded.

The present disclosure further provides a method for image feature extraction, which may comprise:
receiving a to-be-processed image; and
inputting the to-be-processed image into a feature extraction model, to obtain a feature image output by the feature extraction model, where the feature extraction model is generated based on any of the above methods for feature extraction model generation. The feature image can be used for image recognition, image classification of the to-be-processed image. Therefore, with the above technical solution, during the generation process of the feature extraction model, local semantics at different granularities can be learned, ensuring the accuracy of the feature extraction model. Furthermore, the accuracy and comprehensiveness of the features in the feature image can be improved, and accurate data support can be provided for subsequent image classification, image recognition, etc.

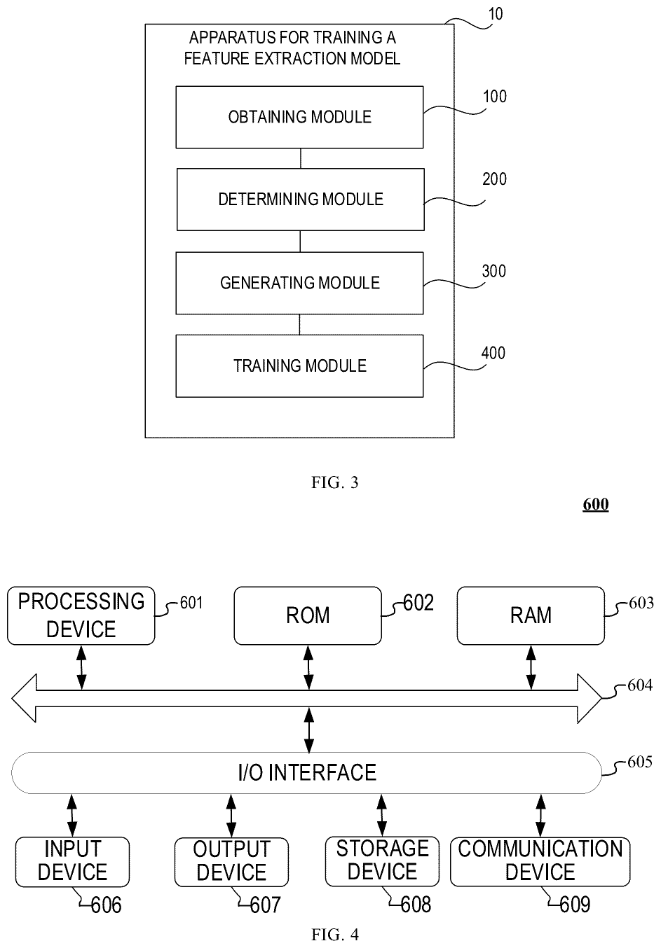

The present disclosure further provides an apparatus for generating a feature extraction model, as shown in FIG. 3, the apparatus comprising:
an obtaining module 100 configured for obtaining a plurality of candidate images;
a determining module 200 configured for determining a clustering tree corresponding to the plurality of candidate images based on a feature extraction model and the plurality of candidate images, wherein the clustering tree comprises clusters at a plurality of layers;
a generating module 300 configured for generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
a training module 400 configured for training the feature extraction model based on the target sample pair.

Optionally, the generating module comprises:
a first generating sub-module configured for generating a sample image set and a candidate contrast image set based on the candidate image, where images in the candidate contrast image set are different from images in the sample image set, and the number of images corresponding to the candidate contrast image set is greater than the number of images corresponding to the sample image set;
a first determining sub-module configured for, with respect to each sample image in the sample image set, determining a contrast sample set of the sample image at each layer based on a candidate contrast image in the candidate contrast image set and a cluster center of the cluster at each layer in the clustering tree, where a contrast sample in the contrast sample set comprises characteristics of a target contrast cluster center and a target contrast image; and
a second generating sub-module configured for generating, for each sample image in the sample image set, a negative sample pair corresponding to the sample image at each layer based on the sample image and a contrast sample set of the sample image at each layer, and determining the negative sample pair as the target sample pair.

Optionally, the first determining sub-module comprises:
a second determining sub-module configured for determining a hierarchical cluster center to which the sample image belongs at each layer in the clustering tree;
a third determining sub-module configured for determining, for each layer in the clustering tree, the target contrast image corresponding to the sample image at the layer based on the hierarchical cluster center to which the sample image belongs at the layer and a candidate contrast image in the candidate contrast image set; and
a fourth determining sub-module configured for determining, for each layer in the clustering tree, the target contrast cluster center corresponding to the sample image at the layer based on the hierarchical cluster center to which the sample image belongs at the layer and each cluster center in the clustering tree.

Optionally, the third determining sub-module comprises:
a fifth determining sub-module configured for determining, for each layer in the clustering tree, an image similarity between the hierarchical cluster center of the sample image at the layer and each candidate contrast image in the candidate contrast image set; and
a sixth determining sub-module configured for performing random sampling based on the image similarity, and in response to that a result of the random sampling is rejection, determining the candidate contrast image as the target contrast image of the sample image at the layer.

Optionally, the fourth determining sub-module comprises:
a seventh determining sub-module configured for determining, with respect to each layer in the clustering tree except the highest layer, a feature similarity between a parent cluster center corresponding to the hierarchical cluster center of the sample image at the layer and a candidate cluster center at the layer except the hierarchical cluster center; and
an eighth determining sub-module configured for performing random sampling based on the feature similarity, and in response to that a result of the random sampling is rejection, determining the candidate cluster center as the target contrast cluster center corresponding to the sample image at the layer.

Optionally, the generating module further comprises:
a third generating sub-module configured for generating, with respect to each sample image in the sample image set, a positive sample pair corresponding to the sample image based on a transformed image of the sample image and the hierarchical cluster center to which the sample image belongs at each layer of the clustering tree.

Optionally, the training module comprises:
a ninth determining sub-module configured for determining a target loss of the feature extraction model based on the target sample pair and a sample label of the target sample pair;
an update submodule configured for, in response to that an iteration ending condition is not met, obtaining an updated feature extraction model by updating parameters of the feature extraction model based on the target loss;
a tenth determining sub-module configured for determining a clustering tree corresponding to the plurality of candidate images based on the updated feature extraction model and the plurality of candidate images; and
a fourth generating sub-module configured for generating a new target sample pair based on the plurality of candidate images and the newly determined clustering tree, so as to train the feature extraction model based on the new target sample pair until the iteration ending condition is met to obtain a trained feature extraction model, where the iteration ending condition is that the target loss is less than or equal to a loss threshold, or the number of iterations of the feature extraction model is greater than a number threshold.

The present disclosure further provides an apparatus for image feature extraction, the apparatus comprising:
a receiving module configured for receiving a to-be-processed image; and
an extraction module configured for inputting the to-be-processed image into a feature extraction model to obtain a feature image output by the feature extraction model, where the feature extraction model is generated based on the method for generating a feature extraction model described above.

Referring to FIG. 4, which is a schematic structural diagram of an electronic device 700 suitable for implementing the embodiments of the present disclosure. The electronic device in the embodiments of the present disclosure may include, but is not limited to, mobile terminals such as a mobile phone, a notebook computer, a digital broadcast receiver, a personal digital assistant (PDA), a PAD (tablet computer), a portable media player (PMP) and a vehicle-mounted terminal (for example, a vehicle-mounted navigation terminal), and fixed terminals such as a digital television (TV) and a desktop computer. The electronic device shown in FIG. 4 is merely an example and should not impose any restrictions on the functions and scope of use of the embodiments of the present application.

As shown in FIG. 4, the electronic device 600 may include a processing device (such as a central processing unit and a graphics processor) 601, which may execute various appropriate actions and processing according to a program stored in a read-only memory (ROM) 602 or a program loaded to a random access memory (RAM) 603 from a storage device 608. Various programs and data required during operation of the electronic device 600 are also stored in the RAM 603. The processing device 601, the ROM 602 and the RAM 603 are connected with one another via a bus 604. An input/output (I/O) interface 605 is also connected to the bus 604.

Generally, the following apparatuses may be connected to the I/O interface 605: an input device 606 including for example a touch screen, a touch pad, a keyboard, a mouse, a camera, a microphone, an accelerometer and a gyroscope; an output device 607 including for example a liquid crystal display (LCD), a speaker and a vibrator; a storage device 608 including for example a magnetic tape and a hard disk; and a communication device 609. The communication device 609 may allow wireless or wired communication between the electronic device 600 and other devices for data exchange. Although FIG. 4 shows the electronic device 600 having various devices, it should be understood that not all the devices shown are necessarily required to be implemented or provided. More or fewer devices may alternatively be implemented or provided.

In particular, according to the embodiments of the present disclosure, the process described above with reference to the flowcharts may be implemented as a computer software program. For example, an embodiment of the present disclosure provides a computer program product including a computer program carried on a non-transient computer-readable medium. The computer program includes a program code for executing the methods shown in the flowcharts. In such an embodiment, the computer program may be downloaded and installed from the network via the communication device 609, or installed from the storage device 608, or installed from the ROM 602. The computer program, when executed by the processing unit 601, causes the processing unit to execute the above functions defined in the methods according to the embodiments of the present disclosure.

It should be noted that the computer-readable medium according to the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus, or device, or any combination thereof. More specific examples of the computer-readable storage medium include but are not limited to: an electrical connection with at least one wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program. The program may be used by or used in combination with an instruction execution system, apparatus, or device. However, in the present disclosure, the computer-readable signal medium may include a data signal propagated in baseband or as a part of a carrier wave, and computer-readable program code is carried therein. This propagated data signal may take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program used by or used in combination with the instruction execution system, apparatus, or device. The program code contained on the computer-readable medium may be transmitted by any suitable medium, including but not limited to, wire, optical cable, RF, etc., or any suitable combination thereof.

In some implementations, a client and server may communicate using any currently known or future developed network protocol such as HTTP (HyperText Transfer Protocol) and may interconnect with any form or medium of digital data communication (such as communication networks). Examples of communication networks include Local Area Networks (LANs), Wide Area Networks (WANs), the Internet (such as the Internet), and end-to-end networks (such as ad hoc end-to-end networks), as well as any network currently known or future developed.

The computer-readable medium may be included in the electronic device described above; or it may stand alone without being assembled into the electronic device.

The computer-readable medium carries one or more programs. When the one or more programs are executed by the electronic device, the electronic device is caused to: obtain a plurality of candidate images; determining a clustering tree corresponding to the plurality of candidate images based on a feature extraction model and the plurality of candidate images, wherein the clustering tree comprises clusters at a plurality of layers; generate a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and train the feature extraction model based on the target sample pair.

Alternatively, the computer-readable medium carries one or more programs. When the one or more programs are executed by the electronic device, the electronic device is caused to: receive an image to be processed; and input the image to be processed into a feature extraction model to obtain a feature image output by the feature extraction model, wherein the feature extraction model is generated based on the method of feature extraction model generation.

The computer program code for performing the operations of the present disclosure may be written in one or more programming languages or a combination thereof, which include but are not limited to object-oriented programming languages Java, Smalltalk, C++, and conventional procedural programming languages such as “C” or similar programming languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and the block diagrams in the drawings illustrate system architectures, functions and operations that may be implemented based on the system, method, and computer program product according to various embodiments of the present disclosure. In this regard, each block in the flowcharts or the block diagrams can represent one module, a program segment or a part of a code, and the module, the program segment or the part of the code includes at least one executable instruction for implementing specific logic functions. It should also be noted that, in some alternative implementations, the functions noted in the blocks may also occur in a sequence different from those illustrated in the drawings. For example, two consecutive blocks may be executed substantially in parallel, and may sometimes be executed in an opposite order, depending on the functions involved. It should also be noted that each block in the block diagrams and/or the flowcharts, and combinations of the blocks in the block diagrams and/or the flowcharts can be implemented in a dedicated hardware-based system that performs the specified functions or operations, or can be implemented by the combination of dedicated hardware and computer instructions.

The units involved in the embodiments described in this application may be implemented in software or hardware. Herein, the name of the unit/module does not constitute a limitation on the unit itself in some cases. For example, a voice data collection module may further be described as “a data collection module”.

The functions described above herein may be at least partially performed by one or more hardware logic components. For example, non-restrictively, example types of hardware logic components that may be used include: a field programmable gate array (FPGA), an application-specific integrated circuit (ASIC), an application-specific standard parts (ASSP), a system-on-chip (SOC), a complex programmable logic device (CPLD), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

According to one or more embodiments of the present disclosure, example 1 provides a method of feature extraction model generation, comprising:
obtaining a plurality of candidate images;
determining a clustering tree corresponding to the plurality of candidate images based on a feature extraction model and the plurality of candidate images, wherein the clustering tree comprises clusters at a plurality of layers;
generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
training the feature extraction model based on the target sample pair.

According to one or more embodiments of the present disclosure, example 2 provides a method of example 1, wherein the generating a target sample pair based on the plurality of candidate images and the clustering tree comprises:
generating a sample image set and a candidate contrast image set based on the candidate images, wherein images in the candidate contrast image set are different from images in the sample image set, and the number of images corresponding to the candidate contrast image set is greater than the number of images corresponding to the sample image set;
determining, for each sample image in the sample image set, a contrast sample set for the sample image at each layer based on candidate contrast images in the candidate contrast image set and a cluster center of the cluster at each layer in the clustering tree, a contrast sample in the contrast sample set comprising features of a target contrast cluster center and a target contrast image; and
generating, for each sample image in the sample image set, a negative sample pair corresponding to the sample image at each layer based on the sample image and the contrast sample set for the sample image at each layer, and determining the negative sample pair as the target sample pair.

According to one or more embodiments of the present disclosure, example 3 provides a method of example 2, wherein determining a contrast sample set for the sample image at each layer based on candidate contrast images in the candidate contrast image set and a cluster center of the cluster at each layer in the clustering tree comprises:
determining a hierarchical cluster center to which the sample image belongs at each layer in the clustering tree;
determining, for each layer in the clustering tree, the target contrast image corresponding to the sample image at the layer based on the hierarchical cluster center to which the sample image belongs at the layer and candidate contrast images in the candidate contrast image set; and
determining, for each layer in the clustering tree, the target contrast cluster center corresponding to the sample image at the layer based on the hierarchical cluster center to which the sample image belongs at the layer and each cluster center in the clustering tree.

According to one or more embodiments of the present disclosure, example 4 provides a method of example 3, wherein the determining, for each layer in the clustering tree, the target contrast image corresponding to the sample image at the layer based on the hierarchical cluster center to which the sample image belongs at the layer and candidate contrast images in the candidate contrast image set comprises:
determining, for each layer in the clustering tree, an image similarity between the hierarchical cluster center of the sample image at the layer and each candidate contrast image in the candidate contrast image set; and
performing random sampling based on the image similarity, and in response to that a result of the random sampling is rejection, determining the candidate contrast image as the target contrast image of the sample image at the layer.

According to one or more embodiments of the present disclosure, example 5 provides a method of example 3, wherein the determining, for each layer in the clustering tree, the target contrast cluster center corresponding to the sample image at the layer based on the hierarchical cluster center to which the sample image belongs at the layer and each cluster center in the clustering tree comprises:
determining, for each layer in the clustering tree except the highest layer, a feature similarity between a parent cluster center corresponding to the hierarchical cluster center of the sample image at the layer and a candidate cluster center at the layer except the hierarchical cluster center; and
performing random sampling based on the feature similarity, and in response to that a result of the random sampling is rejection, determining the candidate cluster center as the target contrast cluster center corresponding to the sample image at the layer.

According to one or more embodiments of the present disclosure, example 6 provides a method of example 2, wherein the generating a target sample pair based on the plurality of candidate images and the clustering tree further comprises:
generating, for each sample image in the sample image set, a positive sample pair corresponding to the sample image based on a transformed image corresponding to the sample image and the hierarchical cluster center to which the sample image belongs at each layer of the clustering tree.

According to one or more embodiments of the present disclosure, example 7 provides a method of example 1, wherein the training the feature extraction model based on the target sample pair comprises:
determining a target loss for the feature extraction model based on the target sample pair and a sample label of the target sample pair;
in response to that an iteration ending condition is not met, obtaining an updated feature extraction model by updating parameters of the feature extraction model based on the target loss;
determining a clustering tree corresponding to the plurality of candidate images based on the updated feature extraction model and the plurality of candidate images; and
generating a new target sample pair based on the plurality of candidate images and the newly determined clustering tree, so as to train the feature extraction model based on the new target sample pair until the iteration ending condition is met to obtain a trained feature extraction model, wherein the iteration ending condition is that the target loss is less than or equal to a loss threshold, or the number of iterations of the feature extraction model is greater than a number threshold.

According to one or more embodiments of the present disclosure, example 8 provides a method of image feature extraction, the method comprising:
receiving an image to be processed; and
inputting the image to be processed into a feature extraction model to obtain a feature image output by the feature extraction model, wherein the feature extraction model is generated based on the method of feature extraction model generation according to any of examples 1 to 7.

According to one or more embodiments of the present disclosure, example 9 provides an apparatus for feature extraction model generation, the apparatus comprising:
an obtaining module configured for obtaining a plurality of candidate images;
a determining module configured for determining a clustering tree corresponding to the plurality of candidate images based on a feature extraction model and the plurality of candidate images, wherein the clustering tree comprises clusters at a plurality of layers;
a generating module configured for generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
a training module configured for training the feature extraction model based on the target sample pair.

According to one or more embodiments of the present disclosure, example 10 provides an apparatus for image feature extraction, the apparatus comprising:
a receiving module configured for receiving an image to be processed; and
an extracting module configured for inputting the image to be processed into a feature extraction model to obtain a feature image output by the feature extraction model, wherein the feature extraction model is generated based on the method of feature extraction model generation according to any of examples 1 to 7.

According to one or more embodiments of the present disclosure, example 11 provides a computer-readable medium, storing a computer program thereon, wherein the program, when executed by a processing device, implements the steps of the method according to any of examples 1 to 8.

According to one or more embodiments of the present disclosure, example 1 provides an electronic device, comprising:
a storage device, storing at least one computer program thereon;
at least one processing device, for executing the at least one computer program in the storage device to implement the steps of the method according to any of examples 1 to 8.

The above description is only for the preferred embodiments disclosed in this disclosure and an explanation of the technical principles used. Those skilled in this field should understand that the scope of disclosure referred to in this disclosure is not limited to technical solutions formed by specific combinations of the aforementioned technical features, and should also cover other technical solutions formed by arbitrary combinations of the aforementioned technical features or their equivalent features without departing from the disclosed concept. For example, a technical solution formed by replacing the above features with (but not limited to) technical features with similar functions disclosed in this disclosure.

Furthermore, although the operations are depicted in a specific order, this should not be understood as requiring them to be executed in the specific order shown or in sequential order. In certain environments, multitasking and parallel processing may be advantageous. Similarly, although several specific implementation details are included in the above discussion, these should not be interpreted as limitations on the scope of this disclosure. Some features described in the context of individual embodiments can also be combined to be implemented in a single embodiment. On the contrary, various features described in the context of a single embodiment can also be implemented separately or in any suitable sub combination in multiple embodiments.

Although the subject matter has been described in language specific to structural features and/or method logical actions, it should be understood that the subject matter limited in the attached claims may not necessarily be limited to the specific features or actions described above. On the contrary, the specific features and actions described above are only exemplary forms of implementing the claims. Regarding the device in the above embodiments, the specific ways in which each module performs operations have been described in detail in the relevant embodiments of the method, and will not be elaborated here.

1-12. (canceled)

13. A method of feature extraction model generation, comprising:
obtaining a plurality of candidate images;
determining a clustering tree corresponding to the plurality of candidate images based on a feature extraction model and the plurality of candidate images, wherein the clustering tree comprises clusters at a plurality of layers;
generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
training the feature extraction model based on the target sample pair.

14. The method according to claim 13, wherein the generating a target sample pair based on the plurality of candidate images and the clustering tree comprises:
generating a sample image set and a candidate contrast image set based on the candidate images, wherein images in the candidate contrast image set are different from images in the sample image set, and the number of images corresponding to the candidate contrast image set is greater than the number of images corresponding to the sample image set;
determining, for each sample image in the sample image set, a contrast sample set for the sample image at each layer based on candidate contrast images in the candidate contrast image set and a cluster center of the cluster at each layer in the clustering tree, a contrast sample in the contrast sample set comprising features of a target contrast cluster center and a target contrast image; and
generating, for each sample image in the sample image set, a negative sample pair corresponding to the sample image at each layer based on the sample image and the contrast sample set for the sample image at each layer, and determining the negative sample pair as the target sample pair.

15. The method according to claim 14, wherein determining a contrast sample set for the sample image at each layer based on candidate contrast images in the candidate contrast image set and a cluster center of the cluster at each layer in the clustering tree comprises:
determining a hierarchical cluster center to which the sample image belongs at each layer in the clustering tree;
determining, for each layer in the clustering tree, the target contrast image corresponding to the sample image at the layer based on the hierarchical cluster center to which the sample image belongs at the layer and candidate contrast images in the candidate contrast image set; and
determining, for each layer in the clustering tree, the target contrast cluster center corresponding to the sample image at the layer based on the hierarchical cluster center to which the sample image belongs at the layer and each cluster center in the clustering tree.

16. The method according to claim 15, wherein the determining, for each layer in the clustering tree, the target contrast image corresponding to the sample image at the layer based on the hierarchical cluster center to which the sample image belongs at the layer and candidate contrast images in the candidate contrast image set comprises:
determining, for each layer in the clustering tree, an image similarity between the hierarchical cluster center of the sample image at the layer and each candidate contrast image in the candidate contrast image set; and
performing random sampling based on the image similarity, and in response to that a result of the random sampling is rejection, determining the candidate contrast image as the target contrast image of the sample image at the layer.

17. The method according to claim 15, wherein the determining, for each layer in the clustering tree, the target contrast cluster center corresponding to the sample image at the layer based on the hierarchical cluster center to which the sample image belongs at the layer and each cluster center in the clustering tree comprises:
determining, for each layer in the clustering tree except the highest layer, a feature similarity between a parent cluster center corresponding to the hierarchical cluster center of the sample image at the layer and a candidate cluster center at the layer except the hierarchical cluster center; and
performing random sampling based on the feature similarity, and in response to that a result of the random sampling is rejection, determining the candidate cluster center as the target contrast cluster center corresponding to the sample image at the layer.

18. The method according to claim 14, wherein the generating a target sample pair based on the plurality of candidate images and the clustering tree further comprises:
generating, for each sample image in the sample image set, a positive sample pair corresponding to the sample image based on a transformed image corresponding to the sample image and the hierarchical cluster center to which the sample image belongs at each layer of the clustering tree.

19. The method according to claim 13, wherein the training the feature extraction model based on the target sample pair comprises:
determining a target loss for the feature extraction model based on the target sample pair and a sample label of the target sample pair;
in response to that an iteration ending condition is not met, obtaining an updated feature extraction model by updating parameters of the feature extraction model based on the target loss;
determining a clustering tree corresponding to the plurality of candidate images based on the updated feature extraction model and the plurality of candidate images; and
generating a new target sample pair based on the plurality of candidate images and the newly determined clustering tree, so as to train the feature extraction model based on the new target sample pair until the iteration ending condition is met to obtain a trained feature extraction model, wherein the iteration ending condition is that the target loss is less than or equal to a loss threshold, or the number of iterations of the feature extraction model is greater than a number threshold.

20. A non-transitory computer-readable medium, storing a computer program thereon, wherein the program, when executed by a processing device, implements a method of feature extraction model generation, the method comprising:
obtaining a plurality of candidate images;
determining a clustering tree corresponding to the plurality of candidate images based on a feature extraction model and the plurality of candidate images, wherein the clustering tree comprises clusters at a plurality of layers;
generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
training the feature extraction model based on the target sample pair.

21. The medium according to claim 20, wherein the generating a target sample pair based on the plurality of candidate images and the clustering tree comprises:
generating a sample image set and a candidate contrast image set based on the candidate images, wherein images in the candidate contrast image set are different from images in the sample image set, and the number of images corresponding to the candidate contrast image set is greater than the number of images corresponding to the sample image set;
determining, for each sample image in the sample image set, a contrast sample set for the sample image at each layer based on candidate contrast images in the candidate contrast image set and a cluster center of the cluster at each layer in the clustering tree, a contrast sample in the contrast sample set comprising features of a target contrast cluster center and a target contrast image; and
generating, for each sample image in the sample image set, a negative sample pair corresponding to the sample image at each layer based on the sample image and the contrast sample set for the sample image at each layer, and determining the negative sample pair as the target sample pair.

22. The medium according to claim 21, wherein determining a contrast sample set for the sample image at each layer based on candidate contrast images in the candidate contrast image set and a cluster center of the cluster at each layer in the clustering tree comprises:
determining a hierarchical cluster center to which the sample image belongs at each layer in the clustering tree;
determining, for each layer in the clustering tree, the target contrast image corresponding to the sample image at the layer based on the hierarchical cluster center to which the sample image belongs at the layer and candidate contrast images in the candidate contrast image set; and
determining, for each layer in the clustering tree, the target contrast cluster center corresponding to the sample image at the layer based on the hierarchical cluster center to which the sample image belongs at the layer and each cluster center in the clustering tree.

23. The medium according to claim 22, wherein the determining, for each layer in the clustering tree, the target contrast image corresponding to the sample image at the layer based on the hierarchical cluster center to which the sample image belongs at the layer and candidate contrast images in the candidate contrast image set comprises:
determining, for each layer in the clustering tree, an image similarity between the hierarchical cluster center of the sample image at the layer and each candidate contrast image in the candidate contrast image set; and
performing random sampling based on the image similarity, and in response to that a result of the random sampling is rejection, determining the candidate contrast image as the target contrast image of the sample image at the layer.

24. The medium according to claim 22, wherein the determining, for each layer in the clustering tree, the target contrast cluster center corresponding to the sample image at the layer based on the hierarchical cluster center to which the sample image belongs at the layer and each cluster center in the clustering tree comprises:
determining, for each layer in the clustering tree except the highest layer, a feature similarity between a parent cluster center corresponding to the hierarchical cluster center of the sample image at the layer and a candidate cluster center at the layer except the hierarchical cluster center; and
performing random sampling based on the feature similarity, and in response to that a result of the random sampling is rejection, determining the candidate cluster center as the target contrast cluster center corresponding to the sample image at the layer.

25. The medium according to claim 21, wherein the generating a target sample pair based on the plurality of candidate images and the clustering tree further comprises:
generating, for each sample image in the sample image set, a positive sample pair corresponding to the sample image based on a transformed image corresponding to the sample image and the hierarchical cluster center to which the sample image belongs at each layer of the clustering tree.

26. The medium according to claim 20, wherein the training the feature extraction model based on the target sample pair comprises:
determining a target loss for the feature extraction model based on the target sample pair and a sample label of the target sample pair;
in response to that an iteration ending condition is not met, obtaining an updated feature extraction model by updating parameters of the feature extraction model based on the target loss;
determining a clustering tree corresponding to the plurality of candidate images based on the updated feature extraction model and the plurality of candidate images; and
generating a new target sample pair based on the plurality of candidate images and the newly determined clustering tree, so as to train the feature extraction model based on the new target sample pair until the iteration ending condition is met to obtain a trained feature extraction model, wherein the iteration ending condition is that the target loss is less than or equal to a loss threshold, or the number of iterations of the feature extraction model is greater than a number threshold.

27. An electronic device, comprising:
a storage device, storing at least one computer program thereon;
at least one processing device, for executing the at least one computer program in the storage device to implement a method of feature extraction model generation, comprising:
obtaining a plurality of candidate images;
determining a clustering tree corresponding to the plurality of candidate images based on a feature extraction model and the plurality of candidate images, wherein the clustering tree comprises clusters at a plurality of layers;
generating a target sample pair based on the plurality of candidate images and the clustering tree, wherein the target sample pair comprises an image sample pair and a feature sample pair, the image sample pair is formed based on two different candidate images, and the feature sample pair is formed based on features of the candidate images and features of cluster centers of the clusters; and
training the feature extraction model based on the target sample pair.

28. The device according to claim 27, wherein the generating a target sample pair based on the plurality of candidate images and the clustering tree comprises:
generating a sample image set and a candidate contrast image set based on the candidate images, wherein images in the candidate contrast image set are different from images in the sample image set, and the number of images corresponding to the candidate contrast image set is greater than the number of images corresponding to the sample image set;
determining, for each sample image in the sample image set, a contrast sample set for the sample image at each layer based on candidate contrast images in the candidate contrast image set and a cluster center of the cluster at each layer in the clustering tree, a contrast sample in the contrast sample set comprising features of a target contrast cluster center and a target contrast image; and
generating, for each sample image in the sample image set, a negative sample pair corresponding to the sample image at each layer based on the sample image and the contrast sample set for the sample image at each layer, and determining the negative sample pair as the target sample pair.

29. The device according to claim 28, wherein determining a contrast sample set for the sample image at each layer based on candidate contrast images in the candidate contrast image set and a cluster center of the cluster at each layer in the clustering tree comprises:
determining a hierarchical cluster center to which the sample image belongs at each layer in the clustering tree;
determining, for each layer in the clustering tree, the target contrast image corresponding to the sample image at the layer based on the hierarchical cluster center to which the sample image belongs at the layer and candidate contrast images in the candidate contrast image set; and
determining, for each layer in the clustering tree, the target contrast cluster center corresponding to the sample image at the layer based on the hierarchical cluster center to which the sample image belongs at the layer and each cluster center in the clustering tree.

30. The device according to claim 29, wherein the determining, for each layer in the clustering tree, the target contrast image corresponding to the sample image at the layer based on the hierarchical cluster center to which the sample image belongs at the layer and candidate contrast images in the candidate contrast image set comprises:
determining, for each layer in the clustering tree, an image similarity between the hierarchical cluster center of the sample image at the layer and each candidate contrast image in the candidate contrast image set; and
performing random sampling based on the image similarity, and in response to that a result of the random sampling is rejection, determining the candidate contrast image as the target contrast image of the sample image at the layer.

31. The device according to claim 29, wherein the determining, for each layer in the clustering tree, the target contrast cluster center corresponding to the sample image at the layer based on the hierarchical cluster center to which the sample image belongs at the layer and each cluster center in the clustering tree comprises:
determining, for each layer in the clustering tree except the highest layer, a feature similarity between a parent cluster center corresponding to the hierarchical cluster center of the sample image at the layer and a candidate cluster center at the layer except the hierarchical cluster center; and
performing random sampling based on the feature similarity, and in response to that a result of the random sampling is rejection, determining the candidate cluster center as the target contrast cluster center corresponding to the sample image at the layer.

32. The device according to claim 28, wherein the generating a target sample pair based on the plurality of candidate images and the clustering tree further comprises:
generating, for each sample image in the sample image set, a positive sample pair corresponding to the sample image based on a transformed image corresponding to the sample image and the hierarchical cluster center to which the sample image belongs at each layer of the clustering tree.
